(19) United States
(12) Patent Application Publication
(10) Pub. No.: US 2006/0170268 A1
(43) Pub. Date: Aug. 3, 2006

(54) Bearing in a vehicle seat

(75) Inventors: Eckhard Nock, Schweitenkirchen (DE); Martin Kraus, Katzenbach (DE); Richard Hansel, Flonheim (DE); Wolfgang Boltze, Kaiserslautern (DE); Karin Becker, Rockenhausen (DE); Larissa Klippert, Weilerbach (DE)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: KEIPER GmbH & Co. KG

(21) Appl. No.: 11/305,912

(22) Filed: Dec. 19, 2005

Related U.S. Application Data
(63) Continuation of application No. PCT/EP04/06403, filed on Jun. 15, 2004.

(30) Foreign Application Priority Data
Jun. 20, 2003 (DE) 103 27 654.8

(51) Int. Cl. B60N 2/02

(52) U.S. Cl. 297/366

(57) ABSTRACT

In a bearing in a vehicle seat, in particular in an automobile seat, having a bearing bolt (25) extending into a hole (43) of an element (23) so that the element (23) is supported on the bearing bolt (25), the hole (43) and/or the bearing bolt (25) have a cross-section that is different from a circle.

### CROSS-REFERENCE TO RELATED APPLICATION

The present application is a continuation of International Application PCT/EP2004/006403, which was filed Jun. 15, 2004. The entire disclosure of International Application PCT/EP2004/006403, which was filed Jun. 15, 2004, is incorporated herein by reference.

### BACKGROUND OF THE INVENTION

The present invention relates to a bearing in a vehicle seat, in particular in an automobile seat, with the bearing having a bearing bolt and an element supported on the bearing bolt.

DE 44 39 644 C2 discloses a locking device with a bearing of the type described in the immediately preceding paragraph, for locking a fitting in a vehicle seat with a swing-free backrest, with the locking device having a spring loaded loading element for loading a locking pawl, and a catch element for supporting the locking pawl in the event of a crash, the loading element and the catch element being made in one piece or in two pieces with a slot-and-bolt guide for coupling. In practice, improvements remain to be made, for example with respect to precision requirements in manufacturing.

### BRIEF SUMMARY OF SOME ASPECTS OF THE INVENTION

An aspect of the present invention is the provision of improvements to a bearing of the type mentioned above. In accordance with one aspect of the present invention, a bearing for a vehicle seat, in particular an automobile seat, has a bearing bolt and an element supported on the bearing bolt. The bearing bolt extends into a hole of the supported element. The hole and/or the bearing bolt have a cross-section that is different from a circle.

By providing the hole, which bears on the bearing bolt, and/or the bearing bolt with a cross section that is different from a circle, one avoids the supported element being borne at a single point, which would cause undesirable rolling of the supported element on the bearing bolt. Depending on the impacting forces, such undesired rolling could result in there being a quick change of position. Higher precision in manufacturing, which would otherwise have to compensate for the consequences of the rolling, is thus made unnecessary. By choosing the appropriate cross-sectional shape of the hole and/or the bearing bolt (preferably an at least generally polygon shape, i.e. with straight and, if needed, curved sections, for example as an approximately quadrangular cross-section, in particular a square cross-section with substantially rounded corners) the supported element can bear on the bearing bolt in at least two touch points, thus maintaining a stable position, over a certain angle area, when there is change in the impacting forces. The hole and/or the bearing bolt can have almost any form between a monogon (which, apart from a rounded corner, has a circular shape) and a polygon including the shape of a star, with two straight sections being preferably at an angle of 90° with respect to one another. It is sufficient for only one of the partners (i.e., the hole and the bearing bolt) to have such a cross-section. The respective other partner may then have a circular cross-section.

The bearing according to the invention is particularly useful in a locking device, namely for at least one locking element and/or at least one securing element. One of the touch points lies preferably approximately in the direction of the contact point between the supported element and a locking element and/or a control element connected to it, from where the largest forces are transferred in the event of a crash. Preferably, both securing elements are supported on a common bearing bolt, both having a hole according to the invention.

The locking device with a bearing according to the invention, with the locking device comprising a corresponding securing device if needed, can be used for a variety of adjusters, i.e. both for rotational adjusters such as, for example, fittings in vehicle seats having a backrest with adjustable inclination and/or a swing-free backrest, and for linear adjusters such as, for example, longitudinal adjusters or height adjusters in diagonal struts. The locking device according to the invention can also be used for a lock for detachably attaching the vehicle seat to the vehicle structure or for locking a foldable vehicle seat into different positions. Depending on their purpose, the locking elements to be secured differ in their structure, whereas the securing elements can remain basically the same.

Other aspects and advantages of the present invention will become apparent from the following.

### BRIEF DESCRIPTION OF THE DRAWINGS

In the following, the present invention is explained in more detail with reference to an exemplary embodiment which is illustrated in the drawings, in which

FIG. 1A is a partial section through the exemplary embodiment in the area of the bearing of the securing element, in a normal position,

FIG. 1B is a partial section through the exemplary embodiment corresponding to FIG. 1A, in the event of a crash,

FIG. 2A is a partial section in the area of the bearing of the previously known securing element corresponding to FIG. 1A, in a normal position,

FIG. 2B is a partial section through the bearing of the previously known securing element corresponding to FIG. 2A, in the event of a crash,

FIG. 3 is a partially sectioned view of a fitting, and

FIG. 4 is a schematic representation of a vehicle seat.

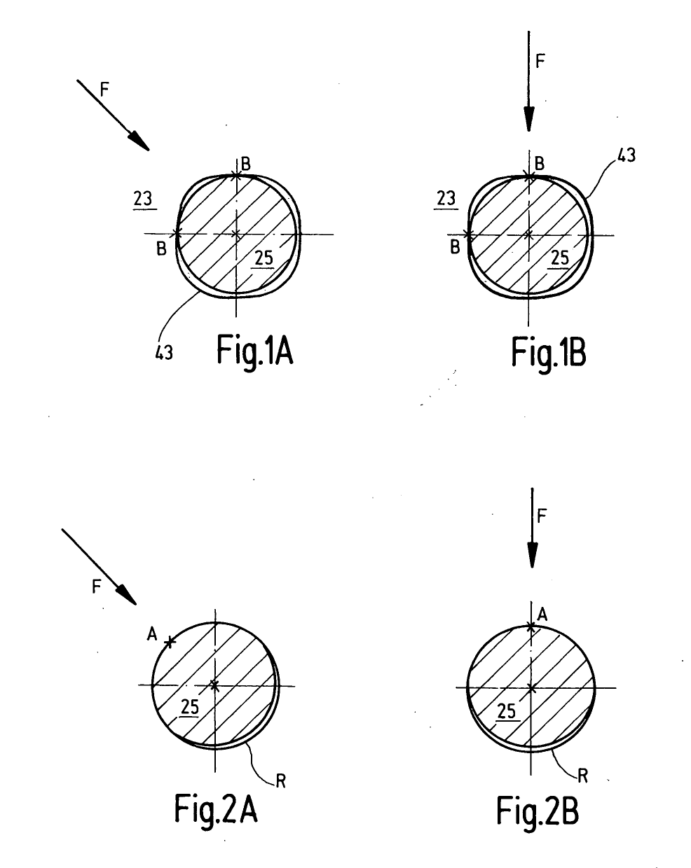

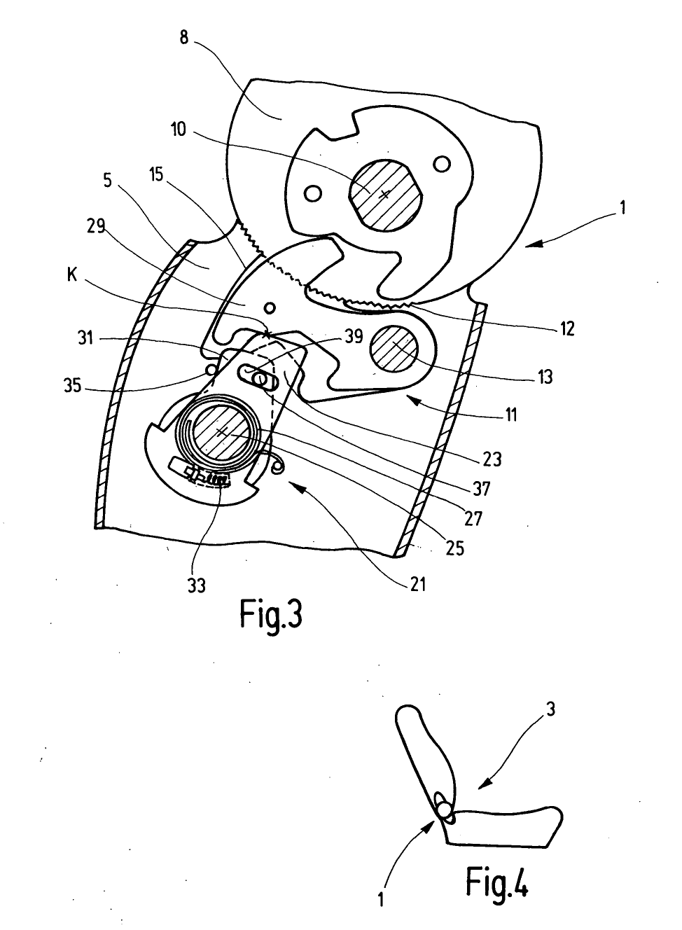

### DETAILED DESCRIPTION OF THE INVENTION

A fitting 1 designed to serve as a detent fitting for a vehicle seat 3 is provided with a lower fitting part 5 that is fixed to structure of the seat part of the vehicle seat, and an upper fitting part 8 that is fixed to structure of the backrest of the vehicle seat. The lower fitting part 5 includes two basically flat plates that are assembled to define the construction space of the lower fitting part 5. The upper fitting part 8 is at least partially arranged inside the construction space of the lower fitting part 5. The upper fitting part 8 is rotatable around a backrest bolt 10 relative to the lower fitting part 5. The vehicle seat 3 has two mirror-image lock fittings 1 bearing the inclination-adjustable and pivotable backrest of the vehicle seat 3. A locking device 11 of the fitting 1 includes a gear wheel rim 12 and a locking pawl 15. The gear wheel rim 12 is on the upper fitting part 8. The gear wheel rim 12 is curved around the backrest bolt 10 in the area facing away from the backrest on the upper fitting part 8. The locking pawl 15 is arranged inside the construction space of the lower fitting part 5, and is pivotably supported on a pawl bearing bolt 13. The locking pawl 15, as a first locking element, and the gear wheel rim 12, as a second locking element, cooperate by meshing depending on the relative position of the fitting parts 5 and 8.

A securing device 21 is provided for the locking device 11. The securing device 21 has, as a first securing element, a generally flat loading eccentric 23 that is pivotably supported on a bearing bolt 25 of the lower fitting part 5 on that side of the locking pawl 15 that is facing away from the gear wheel rim 12. When the fitting 1 is in a locked position, a pre-loaded spiral spring 27 presses the loading eccentric 23 against a control cam 29 that is rotationally fixed to the locking pawl 15, so that the teeth of the locking pawl 15 are pressed into the gear wheel rim 12 (e.g., the locking pawl 15 and the control cam 29 can be collectively referred to as a locking element, which is for meshing with the gear wheel rim 12).

In addition, the securing device 21 has, as a second securing element, a generally flat catch element 31 that is also pivotably supported on the bearing bolt 25. When in a normal position, the catch element 31 is arranged at a distance from the locking pawl 15 that is small compared with the height of the teeth, and is pressed against a lower fitting part-fixed stop 35 that is fixed to the lower fitting part 5. The catch element 31 is pressed against a lower fitting part-fixed stop 35 by means of a pre-loaded, helical-like closing spring 33 that is arranged in a receiving groove of the catch element 31 and acting between the loading eccentric 23 and the catch element 31. In the event of a crash, a torsional moment acts on the upper fitting part 8, having an opening effect of the locking pawl 15 and attempting to press the loading eccentric 23 shut. The locking pawl 15, however, after a minimal pivoting movement, supports itself on the catch element 31 in such a way that meshing between the locking pawl 15 and the gear wheel rim 12 is maintained.

The loading eccentric 23 and the catch element 31 are coupled by means of a slot-and-bolt guide. This slot-and-bolt guide consists of an unlocking bolt 37 on the catch element 31 and a slot 39 formed in the loading eccentric 23. The slot 39 is curved around the bearing bolt 25. When unlocking the fitting 1, the catch element 31 is pivoted back against the spring loads via the unlocking bolt 37, so that the closing spring 33 becomes compressed even further. If the spring force built up by this is larger than that of the spiral spring 27 or, at the latest once the unlocking bolt 37 reaches the end of the slot 39, the loading eccentric 23 is pulled along, i.e. is opened against its spring load. As soon as the catch element 31 comes to bear against a radially protruding carry-along area of the locking pawl 15, the catch element 31 carries along the locking pawl 15, thereby opening the locking pawl 15 and unlocking the fitting 1.

For the loading eccentric 23 and the catch element 31 to pivot easily during operation in all tolerance positions, they are sitting on the bearing bolt 25 with little clearance. The consequences arising from this are now going to be explained in detail using the loading eccentric 23 for an example.

The bearing bolt 25 is positioned in a hole 43 of the eccentric 23, whereby the eccentric 21 sits on the bearing bolt. The hole 43 has a slightly larger cross-section than the bearing bolt 25. The bearing bolt 25 has a circular cross-section. In normal conditions, the relation of forces is determined both by the closing force of the tangentially acting spiral spring 27 and the reaction force in the contact point K between the loading eccentric 23 and the control cam 29. A resulting force F then acts in the area of the hole 43, running at an oblique angle from the line connecting the contact point K and the center of the bearing bolt 25 and defining the point where the loading eccentric 23 bears against the bearing bolt 25. In the event of a crash, major crash forces are transferred via the contact point K which greatly determine the relation of forces, so that a resulting force F is then acting in the area of the hole 43, approximately running along the line connecting the contact point K and the center of the bearing bolt 25.

In a conventional securing element with a round bearing hole R, the location A of the securing element bearing against the bearing bolt 25 would also change due to the change in the resulting force F, by a sliding and rolling movement. Thereby the center of the securing element would be shifted by something close to 10% of the depth of the meshing.

According to the present invention, the hole 43 does not have a circular cross-section but has four additional enlargements of the radius that can also be seen as strongly rounded corners of a square, there occurring no jumps in the gradient and the hole 43 therefore having a smooth rim around its convex cross-sections. Given the chosen shape of the holes 43, the loading eccentric 23 bears against the bearing bolt 25 in two touch points B, “touching” meaning tangential contact. One of the touch points B seen from the bearing bolt 25 lies approximately in the direction of the contact point K with the control cam 29, i.e. eventually in the direction of the locking pawl 15. Thanks to this double support, there is no rolling movement or shifting of the center even in the event of a change in direction of the resulting force K (over a sector of approximately 90°), i.e. the loading eccentric 23 that continues to bear against the bearing bolt 25 in the two touch points B functions in a case-independent manner.

The conditions are analogous when a force is applied to the backrest, for example by seizing and pressing on the upper edge of the backrest. In this case, the direction of the force F changes as well, but the loading eccentric 23 continues to bear on the bearing bolt 25 in the two touch points B, so that the play of the backrest is almost reduced to zero.

For the catch element 31, which has a corresponding hole, the same conditions apply as for the loading eccentric 23.

It will be understood by those skilled in the art that while the present invention has been discussed above with reference to exemplary embodiments, various additions, modifications and changes can be made thereto without departing from the spirit and scope of the invention as set forth in the following claims.

What is claimed is:

1. An apparatus for a seat for a vehicle, the apparatus comprising:
a bearing bolt; and
at least one supported element that includes at least one surface that at least partially defines a hole in the supported element, wherein
the bearing bolt extends into the hole in a manner such that
(a) the supported element is supported on the bearing bolt, and
(b) there can be relative rotation, about an axis of rotation, between the supported element and the bearing bolt,
the supported element being supported on the bearing bolt comprises the at least one surface bearing against the bearing bolt, and
there is at least one noncircular cross-section selected from the group consisting of
(a) a cross-section of the hole taken perpendicular the axis of rotation, and
(b) a cross-section of the bearing bolt taken perpendicular the axis of rotation.

2. The apparatus according to claim 1, wherein the noncircular cross-section is at least generally shaped like a polygon.

3. The apparatus according claim 1, wherein the noncircular cross-section is at least generally shaped like a quadrilateral having substantially rounded corners.

4. The apparatus according to claim 1, wherein the at least one surface bearing against the bearing bolt comprises:
at least two touch points at which the supported element bears against the bearing bolt, with the two touch points being spaced apart from one another.

5. The apparatus according to claim 1, wherein:
the noncircular cross-section is the cross-section of the hole, and
the cross-section of the bearing bolt is circular.

6. The apparatus according to claim 1, further comprising:
first and second components between which there can be relative movement; and
a first locking element, wherein
the supported element is a second locking element,
there can be relative movement between the first and second locking elements, and
the first and second locking elements are for engaging one another to thereby lock the first and second components together so that relative movement between the first and second components is restricted.

7. The apparatus according to claim 1, further comprising:
first and second components between which there can be relative movement; and
a locking device including first and second locking elements, wherein
there can be relative movement between the first and second locking elements,
the first and second locking elements are for engaging one another to thereby lock the first and second components together so that relative movement between the first and second components is restricted,
the supported element is a securing element, and
the securing element is for securing the engaging of the first and second locking elements to one another.

8. The apparatus according to claim 7, wherein:
the securing element being supported on the bearing bolt comprises the securing element being pivotably supported on the bearing bolt; and
the securing element is selected from the group consisting of:
a pre-loaded catch element for supporting the first locking element in the event of a crash, and
a pre-loaded loading element acting on the first locking element for loading the first locking element against the second locking element.

9. The apparatus according to claim 7, wherein:
there is a point of contact between the securing element and the first locking element;
the at least one surface bearing against the bearing bolt comprises at least two touch points at which the securing element bears against the bearing bolt, with the two touch points being spaced apart from one another; and
the bearing bolt's center, one of the touch points, and the contact point are arranged at least approximately in a straight line.

10. The apparatus according to claim 7, wherein:
the securing element being supported on the bearing bolt comprises the securing element being pivotably supported on the bearing bolt;
the securing element is a pre-loaded loading element acting on the first locking element for loading the first locking element against the second locking element;
the locking device further comprises a pre-loaded catch element for supporting the first locking element in the event of a crash; and
the bearing bolt extends into a hole of the catch element in a manner so that the catch element is pivotably supported on the bearing bolt.

11. The apparatus according to claim 1, wherein the apparatus is a locking device for locking a fitting serving as an inclination adjuster in a backrest of the seat.

12. The apparatus according to claim 1, wherein the apparatus is a locking device for attaching the seat to the vehicle.

13. The apparatus according to claim 1 in combination with the vehicle seat, wherein:
the apparatus is a locking device;
the vehicle seat includes an adjuster for allowing relative movement between components of the vehicle seat; and
the locking device is for locking the adjuster and thereby restricting relative movement between the components of the vehicle seat.

14. The apparatus according to claim 1, wherein the noncircular cross-section is at least generally shaped like a polygon with rounded corners.

15. The apparatus according to claim 2, wherein the at least one surface bearing against the bearing bolt comprises:
at least two touch points at which the supported element bears against the bearing bolt, with the two touch points being spaced apart from one another.

16. The apparatus according to claim 6, wherein:
the apparatus is an adjuster for the seat;
the first and second locking elements are parts of locking device of the adjuster;
the first component is a first fitting part of the adjuster; and
the second component is a second fitting part of the adjuster.

17. The apparatus according to claim 2, further comprising:
first and second components between which there can be relative movement; and
a first locking element, wherein
the supported element is a second locking element,
there can be relative movement between the first and second locking elements,
the first and second locking elements are for engaging one another to thereby lock the first and second components together so that relative movement between the first and second components is restricted,
the apparatus is an adjuster for the seat;
the first and second locking elements are parts of locking device of the adjuster,
the first component is a first fitting part of the adjuster, and
the second component is a second fitting part of the adjuster.

18. The apparatus according to claim 4, further comprising:
first and second components between which there can be relative movement; and
a first locking element, wherein
the supported element is a second locking element,
there can be relative movement between the first and second locking elements,
the first and second locking elements are for engaging one another to thereby lock the first and second components together so that relative movement between the first and second components is restricted,
the apparatus is an adjuster for the seat;
the first and second locking elements are parts of locking device of the adjuster,
the first component is a first fitting part of the adjuster, and
the second component is a second fitting part of the adjuster.

19. The apparatus according to claim 7, wherein:
the apparatus is an adjuster for the seat;
the first component is a first fitting part of the adjuster; and
the second component is a second fitting part of the adjuster.

20. The apparatus according to claim 2, further comprising:
first and second components between which there can be relative movement; and
a locking device including first and second locking elements, wherein
there can be relative movement between the first and second locking elements,
the first and second locking elements are for engaging one another to thereby lock the first and second components together so that relative movement between the first and second components is restricted,
the supported element is a securing element,
the securing element is for securing the engaging of the first and second locking elements to one another,
the apparatus is an adjuster for the seat,
the first component is a first fitting part of the adjuster, and
the second component is a second fitting part of the adjuster.

21. The apparatus according to claim 4, further comprising:
first and second components between which there can be relative movement; and
a locking device including first and second locking elements, wherein
there can be relative movement between the first and second locking elements,
the first and second locking elements are for engaging one another to thereby lock the first and second components together so that relative movement between the first and second components is restricted,
the supported element is a securing element,
the securing element is for securing the engaging of the first and second locking elements to one another,
the apparatus is an adjuster for the seat,
the first component is a first fitting part of the adjuster, and
the second component is a second fitting part of the adjuster.

22. The apparatus according to claim 9, wherein the first locking element comprises a locking pawl and a control cam, and the point of contact is between the securing element and the control cam.

23. The apparatus according to claim 10, wherein:
the first locking element comprises a locking pawl and a control cam;
the catch element being for supporting the first locking element in the event of a crash comprises the catch element being for contacting the locking pawl in the event of a crash; and
the loading element acting on the first locking element comprises the loading element contacting the control cam.
